(19) United States
(12) Patent Application Publication
(10) Pub. No.: US 2025/0015346 A1
(43) Pub. Date: Jan. 9, 2025

(54) SOLID ELECTROLYTE MATERIAL, BATTERY USING THE SAME, AND METHOD FOR MANUFACTURING SOLID ELECTROLYTE MATERIAL

(71) Applicant: Panasonic Intellectual Property Management Co., Ltd., Osaka (JP)

(72) Inventors: Ryuhei KATAYAMA, Osaka (JP); Kazufumi MIYATAKE, Osaka (JP); Takashi KUBO, Hyogo (JP); Akinobu MIYAZAKI, Osaka (JP)

(21) Appl. No.: 18/893,003

(22) Filed: Sep. 23, 2024

Related U.S. Application Data
(63) Continuation of application No. PCT/JP2023/004462, filed on Feb. 9, 2023.

(30) Foreign Application Priority Data
Mar. 24, 2022 (JP) 2022-049089

(51) Int. Cl. H01M 10/0562; H01M 10/052

(52) U.S. Cl. CPC H01M 10/0562; H01M 10/052; H01M 2300/008

(57) ABSTRACT

A solid electrolyte material according to the present disclosure includes Li, M, O, and X, wherein the M is at least one selected from the group consisting of Nb and Ta, and the X is at least one selected from the group consisting of F, Cl, Br, and I. The solid electrolyte material according to the present disclosure is amorphous, and in an X-ray diffraction pattern of the solid electrolyte material obtained by X-ray diffraction measurement using Cu—Kα radiation, a peak having a maximum intensity is present as a halo pattern in a diffraction angle 2θ range from 10° to 20°, and the peak has a full width at half maximum of 2° or more.

This application is a continuation of PCT/JP2023/004462 filed on Feb. 9, 2023, which claims foreign priority of Japanese Patent Application No. 2022-049089 filed on Mar. 24, 2022, the entire contents of both of which are incorporated herein by reference.

### BACKGROUND OF THE INVENTION

### 1. Field of the Invention

The present disclosure relates to a solid electrolyte material, a battery using the same, and a method for manufacturing a solid electrolyte material.

### 2. Description of Related Art

WO 2020/137153 discloses a solid electrolyte material including Li, M, O, and X. M is at least one element selected from the group consisting of Nb and Ta, and X is at least one element selected from the group consisting of Cl, Br, and I.

### SUMMARY OF THE INVENTION

The present disclosure aims to provide a solid electrolyte material suitable for reducing the internal resistance and interfacial resistance of batteries.

A solid electrolyte material of the present disclosure is a solid electrolyte material including Li, M, O, and X, wherein the M is at least one selected from the group consisting of Nb and Ta, the X is at least one selected from the group consisting of F, Cl, Br, and I, the solid electrolyte material is amorphous, and in an X-ray diffraction pattern of the solid electrolyte material obtained by X-ray diffraction measurement using Cu—Kα radiation, a peak having a maximum intensity is present as a halo pattern in a diffraction angle 2θ range from 10° to 20°, and the peak has a full width at half maximum of 2° or more.

The present disclosure provides a solid electrolyte material suitable for reducing the internal resistance and interfacial resistance of batteries.

### BRIEF DESCRIPTION OF THE DRAWINGS

FIG. 1 is a flowchart showing an example of a method for manufacturing a solid electrolyte material according to Embodiment 1.

FIG. 2 shows a graph of an example of the X-ray diffraction pattern of a compound synthesized in Synthesis step S01.

FIG. 3 is a cross-sectional view of a battery 1000 according to Embodiment 2.

FIG. 4 shows a graph of the X-ray diffraction pattern of a solid electrolyte material according to Example 1.

FIG. 5 is a schematic diagram of a pressure-molding die 300 used to evaluate the ionic conductivity of solid electrolyte materials.

FIG. 6 shows graphs of the internal resistances of batteries according to Example 1 and Comparative Example 1.

FIG. 7 shows a graph of a Cole-Cole plot of the battery according to Example 1 at 4.30 V.

FIG. 8 shows a graph of the X-ray diffraction pattern of the solid electrolyte material according to Comparative Example 1.

FIG. 9 shows a graph of a Cole-Cole plot of the battery according to Comparative Example 1 at 4.30 V.

FIG. 10 shows a graph of the X-ray diffraction pattern of a solid electrolyte material according to Comparative Example 2.

FIG. 11 shows graphs of the X-ray diffraction patterns of the compound after synthesis and before amorphization, the solid electrolyte material according to Example 1, and the solid electrolyte material according to Comparative Example 1.

### DETAILED DESCRIPTION

Embodiments of the present disclosure are described below with reference to the drawings.

### Embodiment 1

A solid electrolyte material according to Embodiment 1 includes Li, M, O, and X, wherein the M is at least one selected from the group consisting of Nb and Ta, and the X is at least one selected from the group consisting of F, Cl, Br, and I. The solid electrolyte material according to Embodiment 1 is amorphous. In an X-ray diffraction pattern of the solid electrolyte material obtained by X-ray diffraction measurement using Cu—Kα radiation, a peak having a maximum intensity is present as a halo pattern in a diffraction angle 2θ range from 10° to 20°, and the peak has a full width at half maximum of 2θ or more.

The solid electrolyte material according to Embodiment 1 has an amorphous phase, and consequently can reduce the internal resistance and interfacial resistance when used in batteries. Therefore, the solid electrolyte material according to Embodiment 1 is suitable for reducing the internal resistance and interfacial resistance of batteries. The solid electrolyte material according to Embodiment 1 also has a high ionic conductivity. A high lithium-ion conductivity is, for example, 1×10⁻⁴ S/cm or more near room temperature. Room temperature is, for example, 25° C. In other words, the solid electrolyte material according to Embodiment 1 can have an ionic conductivity of, for example, 1×10⁻⁴ S/cm or more.

A full width at half maximum refers to the distance between positions, on both sides of a peak observed in an X-ray diffraction pattern, where the intensity is half the peak intensity. In other words, when a peak has a maximum intensity I_{MAX}, the full width at half maximum is a width defined by the difference between two diffraction angles at which the intensity is I_{hMAX} that is half the value of I_{MAX}.

The halo pattern is defined as a projecting pattern with an SN ratio (i.e., the ratio of a signal S to a background noise N) of 3 or less.

A battery using the solid electrolyte material according to Embodiment 1 is, for example, an all-solid-state battery. The all-solid-state battery may be a primary battery or a secondary battery.

The solid electrolyte material according to Embodiment 1 may be substantially free of sulfur. The solid electrolyte material according to Embodiment 1 being substantially free of sulfur means that the solid electrolyte material does not contain sulfur as its constituent element, except for sulfur unavoidably incorporated as an impurity. In this case, sulfur incorporated as an impurity into the solid electrolyte material is, for example, 1 mol % or less. For safety reasons, the solid electrolyte material according to Embodiment 1 may be free of sulfur. The sulfur-free solid electrolyte material does not generate hydrogen sulfide, which is noxious, when exposed to the atmosphere, and is accordingly excellent in safety.

The solid electrolyte material according to Embodiment 1 may consist substantially of Li, M, O, and X. Here, “the solid electrolyte material according to Embodiment 1 consisting substantially of Li, M, O, and X” means that the ratio (i.e., mole fraction) of the sum of the amounts of substance of Li, M, O, and X to the total of the amounts of substance of all the elements constituting the solid electrolyte material according to Embodiment 1 is 90% or more. In one example, the ratio may be 95% or more.

The solid electrolyte material according to Embodiment 1 may consist of Li, M, O, and X in order to enhance the lithium-ion conductivity of the solid electrolyte material.

The solid electrolyte material according to Embodiment 1 may contain an element unavoidably incorporated. The element is, for example, hydrogen or nitrogen. Such an element can be contained in the raw material powder of the solid electrolyte material or present in an atmosphere for manufacturing or storing the solid electrolyte material. The element unavoidably incorporated into the solid electrolyte material according to Embodiment 1 is, for example, 1 mol % or less.

To enhance the ionic conductivity of the solid electrolyte material, M may include Ta. M may be Ta.

To enhance the ionic conductivity of the solid electrolyte material, X may include Cl. X may be Cl.

The solid electrolyte material according to Embodiment 1 may have composition represented by the following composition formula (1):

LiₐMO_{b}X_{c} (1)

where 0.1≤a≤7.0, 0.4≤b≤1.9, and 1.0≤c≤11 are satisfied.

In the composition formula (1), 0.3≤a≤5.0, 0.6≤b≤1.6, and 2.0≤c≤9.0 may be satisfied, and 0.5≤a≤2.0, 0.7≤b≤1.2, and 3.0≤c≤7.0 may be satisfied.

The solid electrolyte material according to Embodiment 1 may have composition represented by the following composition formula (2):

LiₓMO_{y}X_{(5+x-2y)} (2)

where 0.1<x<7.0 and 0.4<y<1.9 are satisfied.

The above configuration can achieve a solid electrolyte material having a higher lithium-ion conductivity.

To enhance the ionic conductivity of the solid electrolyte material, in the composition formula (2), 0.3<x≤5.0 and 0.6≤y≤1.6 may be satisfied.

To further enhance the ionic conductivity of the solid electrolyte material, in the composition formula (2), 0.5<x≤2.0 and 0.7<y≤1.2 may be satisfied.

The element X may be partially deficient. Specifically, the composition ratio of the element X may be smaller than the value estimated from the molar ratio of the raw materials of the solid electrolyte material (i.e., (5+x−2y) in the composition formula (2)). In one example, the deficiency of the element X is within 30% of 5 +x-2y.

O (i.e., oxygen) may be partially deficient as well.

A deficiency of the element X or O reduces the interaction between lithium ions and an anion, thereby further enhancing the lithium-ion conductivity.

The solid electrolyte material according to Embodiment 1 may have composition represented by Li_{1.2}TaO_{0.8}Cl_{4.0}.

The X-ray diffraction pattern of the solid electrolyte material according to Embodiment 1 can be measured by the θ-2θ method using Cu—Kα radiation (wavelengths of 1.5405 Å and 1.5444 Å) as the X-ray source.

The solid electrolyte material according to Embodiment 1 is an amorphous material in which the X-ray diffraction pattern does not exhibit a peak having an SN ratio of greater than 3.

The solid electrolyte material according to Embodiment 1 has a shape that is not particularly limited. The shape is, for example, acicular, columnar, spherical, or ellipsoidal. The solid electrolyte material according to Embodiment 1 may be particulate. The solid electrolyte material according to Embodiment 1 may be formed into a pellet or plate shape by stacking a plurality of the particles and applying pressure to the stack.

In the case where the solid electrolyte material according to Embodiment 1 is particulate (e.g., spherical), the solid electrolyte material may have a median diameter of 100 μm or less.

The median diameter of the solid electrolyte material is determined from a volumetric particle size distribution measured with a laser diffraction scattering particle size analyzer. The median diameter means the particle diameter (d50) at a cumulative volume equal to 50% in the particle size distribution.

The solid electrolyte material according to Embodiment 1 may have a median diameter of 10 μm or less and may have a median diameter of 5 μm or less. With the above configuration, using the solid electrolyte material in the positive or negative electrode plate of a battery promises to enhance dispersibility. With the enhanced dispersibility in the electrode plate, the battery has favorable charge and discharge characteristics.

### Method for Manufacturing Solid Electrolyte Material

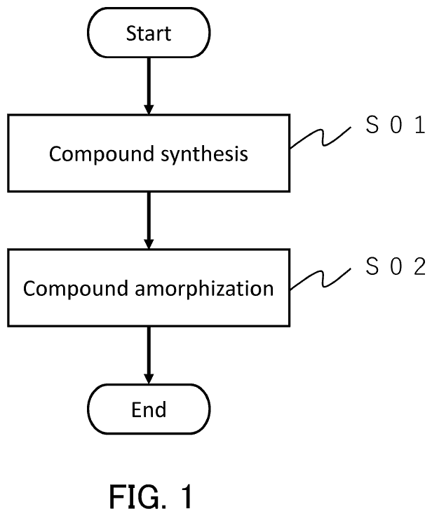

A method for manufacturing the solid electrolyte material according to Embodiment 1 is described below with reference to FIG. 1. FIG. 1 is a flowchart showing an example of the method for manufacturing the solid electrolyte material according to Embodiment 1.

The method for manufacturing the solid electrolyte material according to Embodiment 1 includes synthesizing a compound (S01) and amorphizing the compound synthesized (making the synthesized compound amorphous) (S02). The step of synthesizing a compound is hereinafter referred to as a synthesis step, and the step of amorphizing the compound synthesized is hereinafter referred to as an amorphization step (step of making the synthesized compound amorphous). Synthesis step S01 and Amorphization step S02 are conducted in this order. In Synthesis step S01, a compound including Li, M, O, and X is synthesized. M is at least one selected from the group consisting of Nb and Ta, and X is at least one selected from the group consisting of F, Cl, Br, and I. In Amorphization step S02, the compound synthesized in Synthesis step S01 is amorphized.

In Synthesis step S01, a compound including Li, M, O, and X may be synthesized through reaction by firing of a raw material mixture.

In Synthesis step S01, raw material powders are first prepared to obtain a desired composition. Examples of the raw material powders include a hydroxide, a halide, and an acid halide.

In one example, a solid electrolyte material is composed of Li, Ta, O, and Cl and has a molar ratio Li/M of 1.2 and a molar ratio O/X of 0.17 in mixing the raw materials. In this case, Li₂O, LiOH, and TaCls are prepared in a molar ratio of Li2O:LiOH:TaCl₅=0.4:0.4:1.0. The elemental species of M and X are determined by selecting the raw material powders. The molar ratios Li/M and O/X are determined by selecting the mixing ratio between the raw material powders.

The mixture of the raw material powders is fired to obtain a reaction product. To suppress evaporation of the raw materials due to firing, the mixture of the raw material powders is sealed in an airtight container made of quartz glass or borosilicate glass and fired in a vacuum or an inert gas atmosphere. The inert gas is, for example, argon or nitrogen. Subsequently, coarse pulverization may be conducted with a pulverizer such as a hammer mill or, for a small amount, with a mortar. Thus, a crystalline compound composed of Li, Ta, O, and Cl is synthesized. The compound synthesized in Synthesis step S01, that is, the compound, which includes Li, M, O, and X, synthesized in Synthesis step S01, may be crystalline before Amorphization step S02. More specifically, a compound synthesized including Li, M, O, and X is crystalline as used herein means that in the X-ray diffraction pattern of the compound, the peak having the maximum intensity has a full width at half maximum of less than 2° at 2θand an SN ratio of greater than 3.

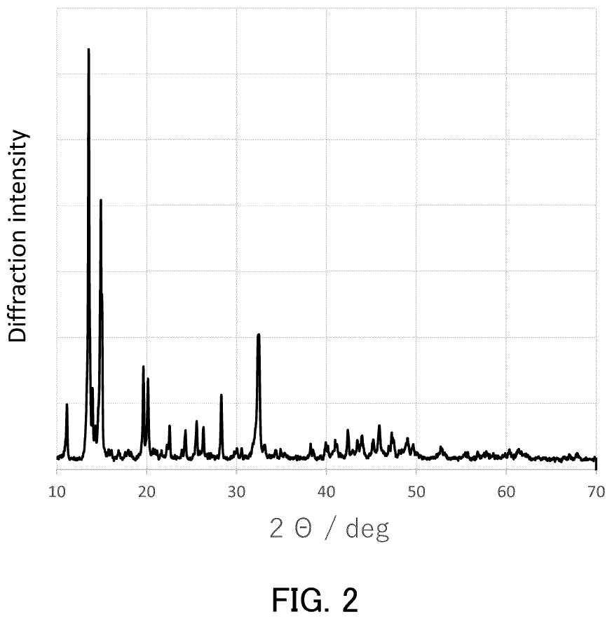

FIG. 2 shows a graph of an example of the X-ray diffraction pattern of the compound synthesized in Synthesis step S01.

The compound synthesized through reaction by firing can be crystalline and have a high ionic conductivity. This can enhance the ionic conductivity of the solid electrolyte material according to Embodiment 1 obtained through the subsequent Amorphization step S02.

In Amorphization step S02, the compound produced in Synthesis step S01 is amorphized. In other words, the crystalline compound is amorphized.

In Amorphization step S02, to amorphize the above compound, a dry milling process is conducted, for example. The dry milling process uses, for example, a dry roll mill, a dry pot mill, a dry planetary ball mill, or a dry bead mill.

In Amorphization step S02, a dry milling process using a dry pot mill may be conducted.

In a dry pot mill, a dry planetary ball mill, and a dry bead mill, a pulverization medium is introduced into a pulverization chamber together with the above crystalline compound produced in Synthesis step S01. The medium is driven by the respective systems to induce collisions and shear between the medium balls or beads or between the medium balls or beads and the inner wall, thereby pulverizing and granulating the above compound.

The shape of the pulverization medium is, for example, spherical or cylindrical. The solid electrolyte material obtained through the pulverization has a particle diameter dependent on the size of the pulverization medium. For example, in the case where the pulverization medium is spherical, the pulverization medium may have a diameter of 0.01 mm or more.

The pulverization medium may have, for example, a spherical shape with a diameter of 1 mm or more and 50 mm or less.

Amorphization step S02 may be conducted in an environment filled with an inert gas. The inert gas is, for example, nitrogen or argon. The temperature for the dry milling process may be, for example, 5° C. or more and 250° C. or less, and the time for the dry milling process may be, for example, 5 minutes or more.

The processing time for Amorphization step S02 may be, for example, 10 hours or more.

Amorphization step S02 may be conducted by glass melting through heating. In this case, the heat treatment is conducted in an environment filled with inert gas. The temperature for the heat treatment may be, for example, 200° C. or more and 1000° C. or less. The time for the heat treatment may be, for example, 1 minute or more and 1440 minutes or less.

The solid electrolyte material according to Embodiment 1 is thus obtained.

### Embodiment 2

Embodiment 2 is described below. The matters described in Embodiment 1 can be omitted as appropriate.

A battery according to Embodiment 2 includes a positive electrode, a negative electrode, and an electrolyte layer. The electrolyte layer is disposed between the positive electrode and the negative electrode. At least one selected from the group consisting of the positive electrode, the electrolyte layer, and the negative electrode includes the solid electrolyte material according to Embodiment 1.

The battery according to Embodiment 2 includes the solid electrolyte material according to Embodiment 1, and consequently has low internal resistance and low grain boundary resistance.

The battery according to Embodiment 2 may be an all-solid-state battery.

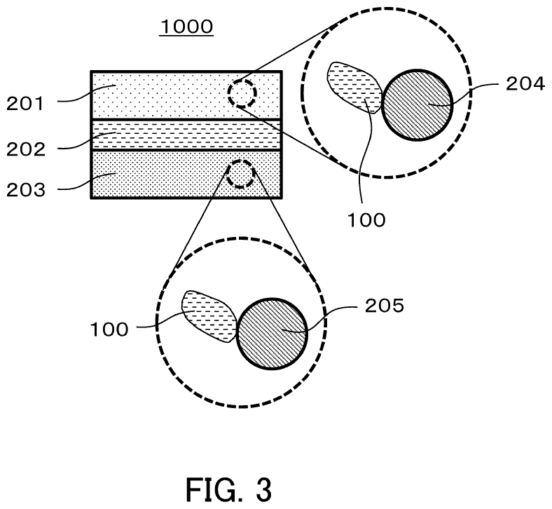

FIG. 3 is a cross-sectional view of a battery 1000 according to Embodiment 2.

The battery 1000 includes a positive electrode 201, an electrolyte layer 202, and a negative electrode 203. The electrolyte layer 202 is disposed between the positive electrode 201 and the negative electrode 203.

The positive electrode 201 includes a positive electrode active material 204 and a solid electrolyte 100.

The negative electrode 203 includes a negative electrode active material 205 and the solid electrolyte 100.

The solid electrolyte 100 includes, for example, the solid electrolyte material according to Embodiment 1. The solid electrolyte 100 is, for example, in the form of particles including the solid electrolyte material according to Embodiment 1 as the main component. The particles including the solid electrolyte material according to Embodiment 1 as the main component mean particles in which the component contained in the highest molar ratio is the solid electrolyte material according to Embodiment 1.

The solid electrolyte 100 may be in the form of particles consisting of the solid electrolyte material according to Embodiment 1.

The positive electrode 201 includes a material capable of occluding and releasing metal ions (e.g., lithium ions). The material is, for example, the positive electrode active material 204.

Examples of the positive electrode active material 204 include a lithium-containing transition metal oxide, a transition metal fluoride, a polyanion material, a fluorinated polyanion material, a transition metal sulfide, a transition metal oxyfluoride, a transition metal oxysulfide, and a transition metal oxynitride. Examples of the lithium-containing transition metal oxide include Li(Ni,Co,Al)O₂, LiCoO₂, and Li(Ni,Co,Mn)O₂. In the present disclosure, “(A,B,C)” means “at least one selected from the group consisting of A, B, and C”, where A, B, and C each represent an element. The positive electrode active material 204 is not limited to any particular shape. The positive electrode active material 204 may be particulate. To favorably disperse the positive electrode active material 204 and the solid electrolyte 100 in the positive electrode 201, the positive electrode active material 204 may have a median diameter of 0.1 μm or more. The favorable dispersion enhances the charge and discharge characteristics of the battery 1000. To rapidly diffuse lithium in the positive electrode active material 204, the positive electrode active material 204 may have a median diameter of 100 μm or less. The rapid lithium diffusion enables the battery 1000 to operate at a high output. As described above, the positive electrode active material 204 may have a median diameter of 0.1 μm or more and 100 μm or less.

To favorably disperse the positive electrode active material 204 and the solid electrolyte 100 in the positive electrode 201, the positive electrode active material 204 may have a larger median diameter than the solid electrolyte 100.

To enhance the energy density and output of the battery 1000, the ratio of the volume of the positive electrode active material 204 to the sum of the volume of the positive electrode active material 204 and the volume of the solid electrolyte 100 in the positive electrode 201 may be 0.30 or more and 0.95 or less.

To enhance the energy density and output of the battery 1000, the positive electrode 201 may have a thickness of 10 μm or more and 500 μm or less.

The electrolyte layer 202 includes an electrolyte material. The electrolyte material is, for example, a solid electrolyte material. The electrolyte layer 202 may be a solid electrolyte layer.

The solid electrolyte material included in the electrolyte layer 202 may include the solid electrolyte material according to Embodiment 1. The electrolyte layer 202 may include the solid electrolyte material according to Embodiment 1. The solid electrolyte material according to Embodiment 1 may account for 50 mass % or more of the electrolyte layer 202. The solid electrolyte material according to Embodiment 1 may account for 70 mass % or more of the electrolyte layer 202. The solid electrolyte material according to Embodiment 1 may account for 90 mass % or more of the electrolyte layer 202.

The electrolyte layer 202 may consist of the solid electrolyte material according to Embodiment 1.

The solid electrolyte material according to Embodiment 1 is hereinafter referred to as a first solid electrolyte material. A solid electrolyte material different from the first solid electrolyte material is hereinafter referred to as a second solid electrolyte material.

The electrolyte layer 202 may include the first solid electrolyte material, and in addition, include the second solid electrolyte material. In the electrolyte layer 202, the first solid electrolyte material and the second solid electrolyte material may be uniformly dispersed. A layer formed of the first solid electrolyte material and a layer formed of the second solid electrolyte material may be stacked along the stacking direction for the battery 1000.

The electrolyte layer 202 may consist of the second solid electrolyte material. Examples of the second solid electrolyte material include Li₂MgX₄, Li₂FeX₄, Li(Al,Ga,In)X₄, Li₃(Al,Ga,In)X₆, and LiX, where X is at least one selected from the group consisting of F, Cl, Br, and I.

To suppress a short circuit between the positive electrode 201 and the negative electrode 203 and enhance the output of the battery 1000, the electrolyte layer 202 may have a thickness of 1 μm or more and 100 μm or less.

The negative electrode 203 includes a material capable of occluding and releasing metal ions (e.g., lithium ions). The material is, for example, the negative electrode active material 205.

Examples of the negative electrode active material 205 include a metal material, a carbon material, an oxide, a nitride, a tin compound, and a silicon compound. The metal material may be a simple substance of metal or may be an alloy. Examples of the metal material include lithium metal and a lithium alloy. Examples of the carbon material include natural graphite, coke, partially graphitized carbon, a carbon fiber, spherical carbon, artificial graphite, and amorphous carbon. From the viewpoint of capacity density, suitable examples of the negative electrode active material 205 include silicon (i.e., Si), tin (i.e., Sn), a silicon compound, and a tin compound.

The negative electrode active material 205 is not limited to any particular shape. The negative electrode active material 205 may be particulate. To favorably disperse the negative electrode active material 205 and the solid electrolyte 100 in the negative electrode 203, the negative electrode active material 205 may have a median diameter of 0.1 μm or more. The favorable dispersion enhances the charge and discharge characteristics of the battery. To rapidly diffuse lithium in the negative electrode active material 205, the negative electrode active material 205 may have a median diameter of 100 μm or less. The rapid lithium diffusion enables the battery to operate at a high output. As described above, the negative electrode active material 205 may have a median diameter of 0.1 μm or more and 100 μm or less.

To favorably disperse the negative electrode active material 205 and the solid electrolyte 100 in the negative electrode 203, the negative electrode active material 205 may have a larger median diameter than the solid electrolyte 100.

To enhance the energy density and output of the battery 1000, the ratio of the volume of the negative electrode active material 205 to the sum of the volume of the negative electrode active material 205 and the volume of the solid electrolyte 100 in the negative electrode 203 may be 0.30 or more and 0.95 or less.

To enhance the energy density and output of the battery 1000, the negative electrode 203 may have a thickness of 10 μm or more and 500 μm or less.

To enhance the ionic conductivity, chemical stability, and electrochemical stability, at least one selected from the group consisting of the positive electrode 201, the electrolyte layer 202, and the negative electrode 203 may include the second solid electrolyte material. Examples of the second solid electrolyte material include a halide solid electrolyte, a sulfide solid electrolyte, an oxide solid electrolyte, and an organic polymer solid electrolyte.

In the present disclosure, the “sulfide solid electrolyte” refers to a solid electrolyte containing sulfur. The “oxide solid electrolyte” refers to a solid electrolyte containing oxygen. The oxide solid electrolyte, which contains oxygen, may contain another anion (except for a sulfur anion and a halogen anion). The “halide solid electrolyte” refers to a solid electrolyte containing a halogen element and being free of sulfur. The halide solid electrolyte, which contains a halogen element, may contain oxygen.

The second solid electrolyte material may be a halide solid electrolyte. The halide solid electrolyte may be Li₂MgX₄, Li₂FeX₄, Li(Al,Ga,In)X₄, Li₃(Al,Ga,In,Y)X₆, or Lil, as described above.

Another example of the halide solid electrolyte is a compound represented by LiₚMe_{q}YᵣZ₆, where p+m′q+3r=6 and r>0 are satisfied, Me is at least one element selected from the group consisting of metalloid elements and metal elements other than Li or Y, the value of m′ represents the valence of Me, and Z is at least one selected from the group consisting of F, Cl, Br, and I. The “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se).

To enhance the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be Li₃YCl₆ or Li₃YBr₆.

The second solid electrolyte material may be a sulfide solid electrolyte.

Examples of the sulfide solid electrolyte include Li₂S-P₂S₅, Li₂S-SiS₂, Li₂S-B₂S₃, Li₂S-GeS₂, Li_{3.25}Ge_{0.25}P_{0.75S4}, and Li₁₀GeP₂S₁₂.

The second solid electrolyte material may be an oxide solid electrolyte. Examples of the oxide solid electrolyte include:

(i) a NASICON-type solid electrolyte, such as LiTi₂(PO₄)₃ or its element-substituted substance;

(ii) a perovskite-type solid electrolyte, such as (LaLi)TiO₃;

(iii) a LISICON-type solid electrolyte, such as Li₁₄ZnGe₄O₁₆, Li₄SiO₄, LiGeO₄, or its element-substituted substance;

(iv) a garnet-type solid electrolyte, such as Li₇La₃Zr₂O₁₂ or its element-substituted substance; and

(v) Li₃PO₄ and its N-substituted substance.

The second solid electrolyte material may be an organic polymer solid electrolyte.

An example of the organic polymer solid electrolyte is a compound of a polymer compound and a lithium salt. The polymer compound may have an ethylene oxide structure. The polymer compound having an ethylene oxide structure can contain a lithium salt in a large amount, and accordingly has a further enhanced ionic conductivity.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from the above may be used alone. Alternatively, a mixture of two or more lithium salts selected from the above may be used.

At least one selected from the group consisting of the positive electrode 201, the electrolyte layer 202, and the negative electrode 203 may include a nonaqueous electrolyte solution, a gel electrolyte, or an ionic liquid for the purpose of facilitating transfer of lithium ions to enhance the output characteristics of the battery 1000.

The nonaqueous electrolyte solution contains a nonaqueous solvent and a lithium salt dissolved in the nonaqueous solvent.

Examples of the nonaqueous solvent include a cyclic carbonate solvent, a chain carbonate solvent, a cyclic ether solvent, a chain ether solvent, a cyclic ester solvent, a chain ester solvent, and a fluorinated solvent. Examples E of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethylmethyl carbonate, and fluorodimethylene carbonate.

One nonaqueous solvent selected from the above may be used alone. Alternatively, a mixture of two or more nonaqueous solvents selected from the above may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from the above may be used alone. Alternatively, a mixture of two or more lithium salts selected from the above may be used. The lithium salt has a concentration of, for example, 0.5 mol/L or more and 2 mol/L or less.

The gel electrolyte can be a polymer material impregnated with a nonaqueous electrolyte solution. Examples of the polymer material include polyethylene oxide, polyacrylonitrile, polyvinylidene fluoride, polymethylmethacrylate, and a polymer having an ethylene oxide bond.

Examples of the cation contained in the ionic liquid include:

(i) an aliphatic chain quaternary salt, such as tetraalkylammonium or tetraalkylphosphonium;

(ii) an aliphatic cyclic ammonium, such as pyrrolidinium, morpholinium, imidazolinium, tetrahydropyrimidinium, piperazinium, or piperidinium; and

(iii) a nitrogen-containing heterocyclic aromatic cation, such as pyridinium or imidazolium.

Examples of the anion contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻. The ionic liquid may contain a lithium salt.

At least one selected from the group consisting of the positive electrode 201, the electrolyte layer 202, and the negative electrode 203 may include a binder for the purpose of enhancing the adhesion between the particles.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. The binder can also be a copolymer. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the above materials may be used as the binder.

At least one selected from the positive electrode 201 and the negative electrode 203 may include a conductive additive in order to enhance the electronic conductivity.

Examples of the conductive additive include:

(i) graphite, such as natural graphite or artificial graphite;

(ii) carbon black, such as acetylene black or Ketjenblack;

(iii) a conductive fiber, such as a carbon fiber or a metal fiber;

(iv) fluorinated carbon;

(v) a metal powder, such as an aluminum powder;

(vi) a conductive whisker, such as a zinc oxide whisker or a potassium titanate whisker;

(vii) a conductive metal oxide, such as titanium oxide; and

(viii) a conductive polymer compound, such as polyaniline compound, polypyrrole compound, or polythiophene compound. To reduce the cost, the conductive additive in the above (i) or (ii) may be used.

Examples of the shape of the battery according to Embodiment 2 include a coin type, a cylindrical type, a prismatic type, a sheet type, a button type, a flat type, and a stacked type.

The battery according to Embodiment 2 may be manufactured by, for example, preparing a material for forming a positive electrode, a material for forming an electrolyte layer, and a material for forming a negative electrode, and producing by a known method a stack composed of the positive electrode, the electrolyte layer, and the negative electrode disposed in this order.

### Other Embodiments

### Supplementary Description

The description of the embodiments above discloses the following techniques.

### Technique 1

A solid electrolyte material including Li, M, O, and X, wherein

the M is at least one selected from the group consisting of Nb and Ta,

the X is at least one selected from the group consisting of F, Cl, Br, and I,

the solid electrolyte material is amorphous, and

in an X-ray diffraction pattern of the solid electrolyte material obtained by X-ray diffraction measurement using Cu—Kα radiation,

a peak having a maximum intensity is present as a halo pattern in a diffraction angle 20 range from 10° to 20°, and the peak has a full width at half maximum of 2° or more.

The solid electrolyte material according to Technique 1 can reduce the internal resistance and interfacial resistance when used in batteries.

### Technique 2

The solid electrolyte material according to Technique 1, having a median diameter of 10 μm or less as determined from a volumetric particle size distribution measured with a laser diffraction scattering particle size analyzer. This configuration can achieve favorable charge and discharge characteristics when the solid electrolyte material is used in batteries.

### Technique 3

The solid electrolyte material according to Technique 1 or 2, wherein the M includes Ta. This configuration can enhance the ionic conductivity of the solid electrolyte material.

### Technique 4

The solid electrolyte material according to any one of Techniques 1 to 3, wherein the X includes Cl. This configuration can enhance the ionic conductivity of the solid electrolyte material.

### Technique 5

The solid electrolyte material according to any one of Techniques 1 to 4, having composition represented by the following composition formula (1):

LiₐMO_{b}X_{c} (1)

where 0.1≤a≤7.0, 0.4≤b≤1.9, and 1.0≤c≤11 are satisfied. This configuration can achieve a solid electrolyte material suitable for reducing the internal resistance and interfacial resistance of batteries.

### Technique 6

The solid electrolyte material according to any one of Techniques 1 to 5, having composition represented by Li_{1.2}TaO_{0.8}Cl_{4.0}. This configuration can achieve a solid electrolyte material suitable for reducing the internal resistance and interfacial resistance of batteries.

### Technique 7

A battery including:

a positive electrode;

a negative electrode; and

an electrolyte layer disposed between the positive electrode and the negative electrode, wherein

at least one selected from the group consisting of the positive electrode, the negative electrode, and the electrolyte layer includes the solid electrolyte material according to any one of Techniques 1 to 6.

This configuration can achieve a battery having a low internal resistance and a low grain boundary resistance.

### Technique 8

A method for manufacturing the solid electrolyte material according to any one of Techniques 1 to 6, the method including:

synthesizing a compound including Li, M, O, and X; and amorphizing the compound, wherein

the M is at least one selected from the group consisting of Nb and Ta, and

the X is at least one selected from the group consisting of F, Cl, Br, and I.

This configuration can achieve a solid electrolyte material suitable for reducing the internal resistance and interfacial resistance of batteries.

### Technique 9

The method according to Technique 8, wherein in the amorphizing the compound, the compound is subjected to a dry milling process. This configuration can obtain a solid electrolyte material suitable for reducing the internal resistance and interfacial resistance of batteries.

### Technique 10

The method according to Technique 9, wherein the dry milling process includes a process using a dry pot mill. This configuration can obtain a solid electrolyte material suitable for reducing the internal resistance and interfacial resistance of batteries.

### Technique 11

The method according to Technique 9 or 10, wherein the dry milling process uses a spherical medium having a diameter of 1 mm or more and 50 mm or less. This configuration can obtain a solid electrolyte material suitable for reducing the internal resistance and interfacial resistance of batteries.

### Technique 12

The method according to any one of Techniques 8 to 11, wherein the amorphizing the compound is conducted for 10 hours or more. This configuration can obtain a solid electrolyte material suitable for reducing the internal resistance and interfacial resistance of batteries.

### Technique 13

The method according to any one of Techniques 8 to 12, wherein the compound synthesized is crystalline before the amorphizing the compound. This configuration can obtain a solid electrolyte material having a further enhanced ionic conductivity.

### Technique 14

The method according to any one of Techniques 8 to 13, wherein in the synthesizing the compound, the compound is synthesized by firing a raw material mixture. This configuration can obtain a solid electrolyte material having an enhanced ionic conductivity.

### EXAMPLE

The present disclosure is described in more detail below with reference to an example.

### Example 1

### Compound Synthesis

In an argon atmosphere with a dew point of −60° C. or less and an oxygen concentration of 0.0001 volume % or less, Li₂O, LiOH, and TaCls were prepared as the raw material powders in the molar ratio of Li₂O:LiOH:TaCl₅=0.4:0.4:1.0. These materials were pulverized and mixed in an agate mortar. The resulting mixture was placed in a quartz glass container filled with argon gas and fired at 350° C. for 3 hours. The resulting fired product was pulverized in an agate mortar. Thus, a compound composed of Li, Ta, O, and Cl (hereinafter referred to as “LTOC”) was obtained. According to the result of X-ray diffraction measurement on the LTOC obtained, the peak having the maximum intensity had a full width at half maximum of less than 2° at 2Θ and an SN ratio of greater than 3. In other words, the LTOC synthesized had been crystalline before amorphization. The X-ray diffraction measurement was conducted with an X-ray diffractometer (MiniFlex 600 manufactured by Rigaku Corporation) in a dry atmosphere with a dew point of −45° C. or less. The X-ray source used was Cu—Kα radiation (wavelengths of 1.5405 Å and 1.5444 Å).

### Compound Amorphization

The LTOC (4 g) synthesized by the above method was fed into a zirconia pot having a volume of 45 mL. A spherical zirconia pulverization medium (85 g) having a diameter of 10 mm was added to the pot, and pulverization was conducted with a ball mill stand at the rotational speed of 130 rpm for 50 hours. In this manner, a milling process using a dry pot mill was conducted. Subsequently, the pulverization medium and the LTOC were separated with a stainless steel sieve having an aperture size of 212 μm.

Thus, the LTOC was amorphized. In other words, a solid electrolyte material according to Example 1 was obtained.

### X-ray Diffraction Measurement

The solid electrolyte material according to Example 1 was measured for X-ray diffraction pattern with an X-ray diffractometer (MiniFlex 600 manufactured by Rigaku Corporation) in a dry atmosphere with a dew point of −45° C. or less. The X-ray source used was Cu—Kα radiation (wavelengths of 1.5405 Å and 1.5444 Å).

The result of the X-ray diffraction measurement indicates that the peak having the maximum intensity was present as a halo pattern at a diffraction angle 2θ of 13.8°. The peak had a full width at half maximum 3.46° and an SN ratio of 2.9.

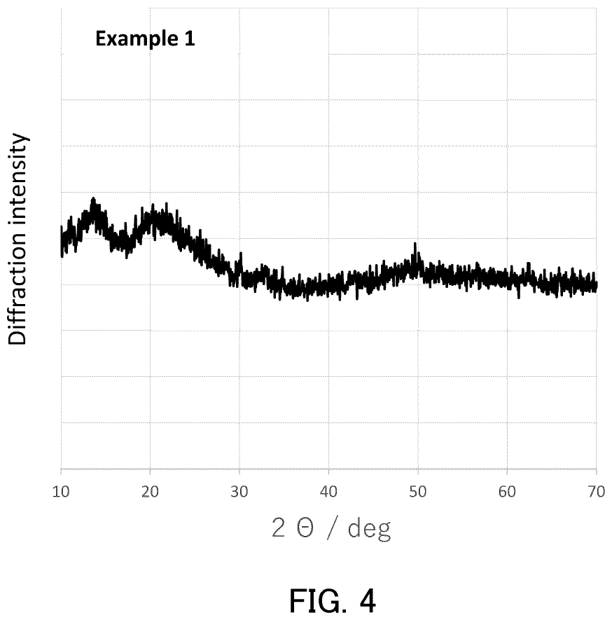

FIG. 4 shows a graph of the X-ray diffraction pattern of the solid electrolyte material according to Example 1.

### Ionic Conductivity Measurement

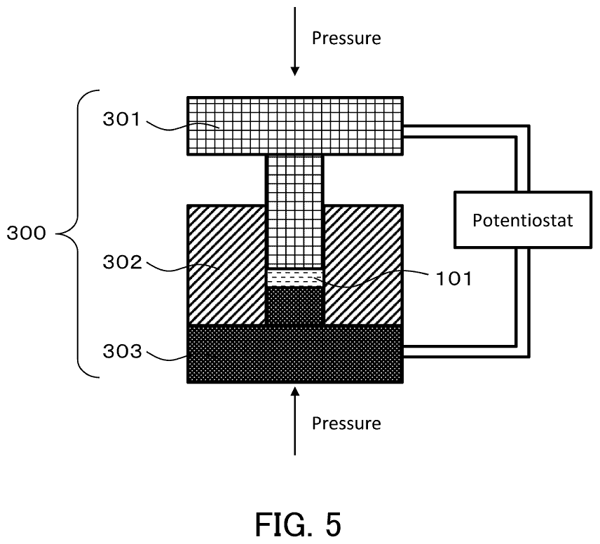

FIG. 5 is a schematic diagram of a pressure-molding die 300 used to evaluate the ionic conductivity of solid electrolyte materials.

The pressure-molding die 300 included an upper punch 301, a die 302, and a lower punch 303. The die 302 was made of polycarbonate, which is insulating. The upper punch 301 and the lower punch 303 were made of stainless steel, which is electronically conductive.

With the pressure-molding die 300 shown in FIG. 5, the solid electrolyte material according to Example 1 was measured for ionic conductivity by the following method.

In a dry argon atmosphere, the pressure-molding die 300 was filled with a powder 101 of the solid electrolyte material according to Example 1. Inside the pressure-molding die 300, a pressure of 300 MPa was applied to the solid electrolyte material with the upper punch 301 and the lower punch 303.

Under the pressure applied, the impedance of the solid electrolyte material according to Example 1 was measured at room temperature through the upper punch 301 and the lower punch 303 by electrochemical impedance measurement using a potentiostat (VersaSTAT4 manufactured by Princeton Applied Research). The upper punch 301 was connected to the working electrode and the potential measurement terminal. The lower punch 303 was connected to the counter electrode and the reference electrode.

In a Cole-Cole plot obtained by the impedance measurement, the real value of the complex impedance at the measurement point where the absolute value of the phase of the complex impedance was smallest was defined as the resistance value of the solid electrolyte material to ionic conduction. The ionic conductivity was calculated from the resistance value by the following mathematical formula (3):

$$σ = {( {R}_{SE} \times S / t )}^{- 1} \qquad ( 3 )$$

where o represents the ionic conductivity; S represents the contact area of the solid electrolyte material with the upper punch 301, in other words, S is equal to the cross-sectional area of the cavity of the die 302 in FIG. 5; R_{SE} represents the resistance value of the solid electrolyte material in the impedance measurement; and t represents the thickness of the solid electrolyte material, in other words, t represents the thickness of the layer formed of the powder 101 of the solid electrolyte material in FIG. 5).

The solid electrolyte material according to Example 1 had an ionic conductivity of 5.7×10⁻³ S/cm measured at 25° C.

### Battery Production

In a dry argon atmosphere, the solid electrolyte material according to Example 1 and an active material Li(NiCoAl)O₂ were weighed in the volume ratio of solid electrolyte material: Li(NiCoAl)O₂=30:70. These materials were mixed in an agate mortar. Thus, a positive electrode mixture was obtained.

In an insulating cylinder with an inner diameter of 9.5 mm, a sulfide solid electrolyte Li₂S-P₂S₅ (100.0 mg), the above positive electrode mixture (10.0 mg), and aluminum powder (20.0 mg) were stacked in order. A pressure of 360 MPa was applied to the stack to form a positive electrode and a solid electrolyte layer.

Next, a metallic Li foil was stacked on the solid electrolyte layer. The solid electrolyte layer was thus sandwiched between the metallic Li foil and the positive electrode. The metallic Li foil had a thickness of 200 μm. A pressure of 80 MPa was applied to the metallic Li foil to form a negative electrode.

Current collectors made of stainless steel were attached to the positive electrode and the negative electrode, and current collector leads were then attached to the current collectors. Lastly, an insulating ferrule was used to block the inside of the insulating cylinder from the outside air atmosphere to hermetically seal the cylinder.

Thus, a battery according to Example 1 was obtained.

### Internal Resistance Measurement

The battery according to Example 1 was placed in a thermostatic chamber set at 25° C. and subjected to constant-current charge at a rate of 0.05 C (20-hour rate) relative to the theoretical capacity of the battery. The end-of-charge voltage was set at 4.30 V (vs. Li).

The battery was then subjected to constant-current discharge at a rate of 0.05 C (20-hour rate) relative to the theoretical capacity of the battery. The end-of-discharge voltage was set at 3.65 V (vs. Li).

The battery was then subjected to constant-current discharge at a rate of 4 C relative to the theoretical capacity of the battery for 10 seconds. The potential difference that had varied over the 10-second duration was divided by the current value, and the resulting quotient was multiplied by the cross-sectional area of the insulating cylinder to determine the internal resistance.

The measurement was conducted with an electrochemical measurement system manufactured by Solartron Analytical.

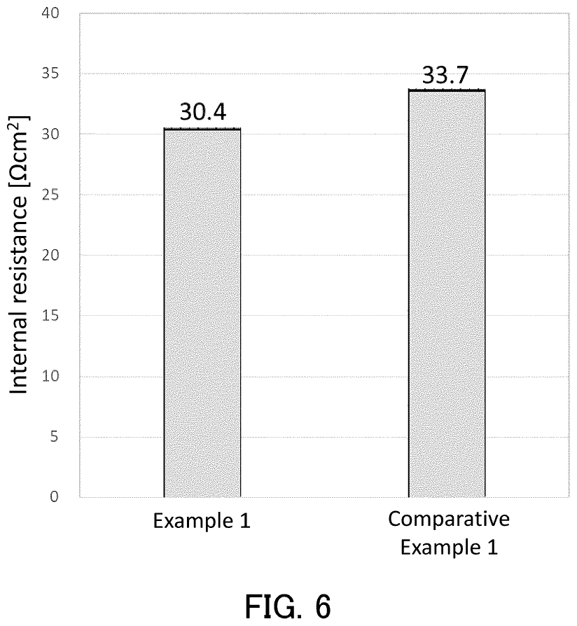

FIG. 6 shows a graph of the internal resistance of the battery according to Example 1.

The result of the internal resistance measurement indicates that the battery according to Example 1 had an internal resistance of 30.4 Ωcm². Here, the internal resistance was 8.8 Ωcm² for the duration from 0.1 seconds to 10 seconds.

### Interfacial Resistance Measurement

The battery according to Example 1 was placed in a thermostatic chamber set at 25° C. and subjected to constant-current charge at a rate of 0.05 C (20-hour rate) relative to the theoretical capacity of the battery. The end-of-charge voltage was set at 4.30 V (vs. Li).

Next, the battery according to Example 1 was measured by an alternating-current impedance method. The voltage amplitude was set to range from −10 mV to +10 mV, and the frequency was set to range from 107 Hz to 10⁻² Hz.

The measurement was conducted with an electrochemical measurement system manufactured by Solartron Analytical.

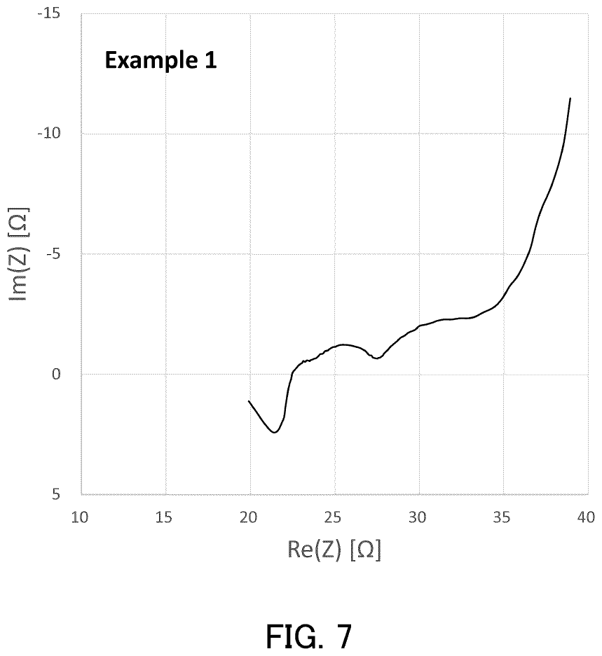

FIG. 7 shows a graph of a Cole-Cole plot of the battery according to Example 1 at 4.30 V. In FIG. 7, the horizontal axis represents the real part of the impedance, and the vertical axis represents the imaginary part of the impedance. The semicircular arc waveform in the Cole-Cole plot was attributed to the resistance component with the positive electrode and to the resistance component with metallic Li as the negative electrode, and curve fitting analysis was conducted. Thus, the interfacial resistance value with the positive electrode was calculated.

The result of the interfacial resistance measurement indicates that the battery according to Example 1 had an interfacial resistance of 5.0 Ω.

### Comparative Example 1

In Comparative Example 1, the mill used for pulverizing to achieve amorphization was changed from a dry pot mill as in Example 1 to a wet planetary ball mill. Specifically, a solid electrolyte material according to Comparative Example 1 was produced as follows.

### Compound Synthesis

LTOC was synthesized in the same manner as in Example 1.

### Compound Pulverization

The LTOC synthesized (4 g) and p-chlorotoluene (16 g) were fed into a zirconia pot having a volume of 45 mL. A spherical zirconia pulverization medium (25 g) having a diameter of 10 mm was added to the pot, and pulverization was conducted with a planetary ball mill (PULVERISETTE 5 manufactured by Fritsch GmbH) at the rotational speed of 300 rpm for 120 minutes. In this manner, a milling process using a wet planetary ball mill was conducted. Subsequently, the pulverization medium was separated from a solution composed of the LTOC and the p-chlorotoluene with a stainless steel sieve having an aperture size of 212 μm. The solution was heated to 175° C. under nitrogen flow to remove the p-chlorotoluene. Thus, the LTOC was micronized.

Through the above processes, the solid electrolyte material according to Comparative Example 1 was obtained.

The solid electrolyte material according to Comparative Example 1 was subjected to X-ray diffraction measurement in the same manner as in Example 1. The result indicates the peak having the maximum intensity was present at a diffraction angle 20 of 13.7°. The peak had a full width at half maximum of 0.15° and an SN ratio of 30.0.

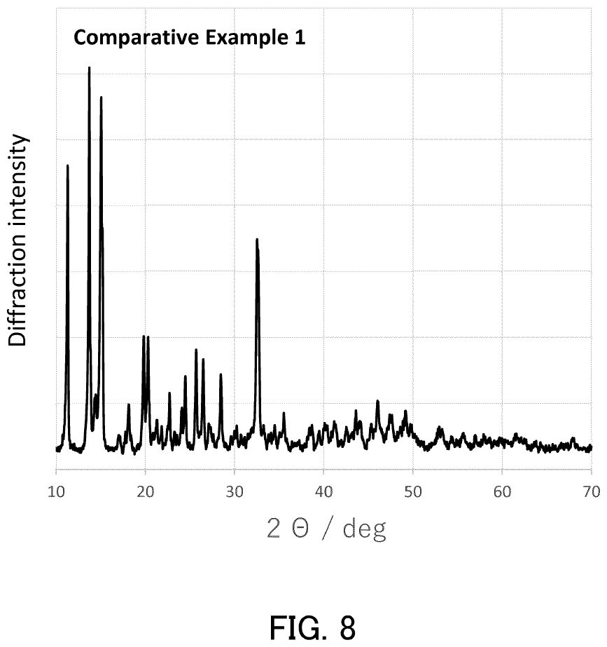

FIG. 8 shows a graph of the X-ray diffraction pattern of the solid electrolyte material according to Comparative Example 1.

The solid electrolyte material according to Comparative Example 1 was subjected to ionic conductivity measurement in the same manner as in Example 1. The result indicates that the solid electrolyte material according to Comparative Example 1 had an ionic conductivity of 5.0×10⁻³ S/cm.

The solid electrolyte material according to Comparative Example 1 was used to produce a battery according to Comparative Example 1 in the same manner as in Example 1, and the battery was subjected to internal resistance measurement and interfacial resistance measurement. The battery according to Comparative Example 1 had an internal resistance of 33.7 Ωcm². Here, the internal resistance was 12.2 Ωcm² for the duration from 0.1 seconds to 10 seconds. The battery according to Comparative Example 1 had an interfacial resistance of 6.1 Ω.

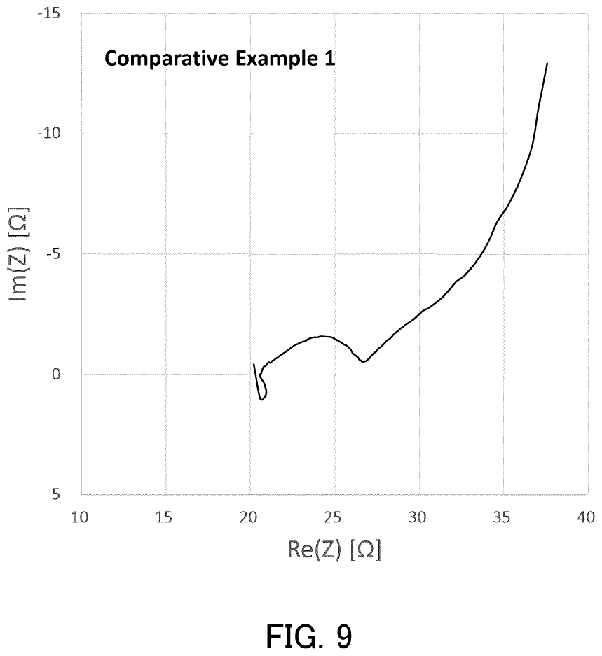

FIG. 6 shows graphs of the internal resistances of the batteries according to Example 1 and Comparative Example 1. FIG. 9 shows a graph of a Cole-Cole plot of the battery according to Comparative Example 1 at 4.30 V.

### Comparative Example 2

The duration for the milling process using a wet planetary ball mill in the pulverization step was changed from that in Comparative Example 1 to 100 hours. Except for the above, the same procedure as in Comparative Example 1 was conducted to obtain a solid electrolyte material according to Comparative Example 2.

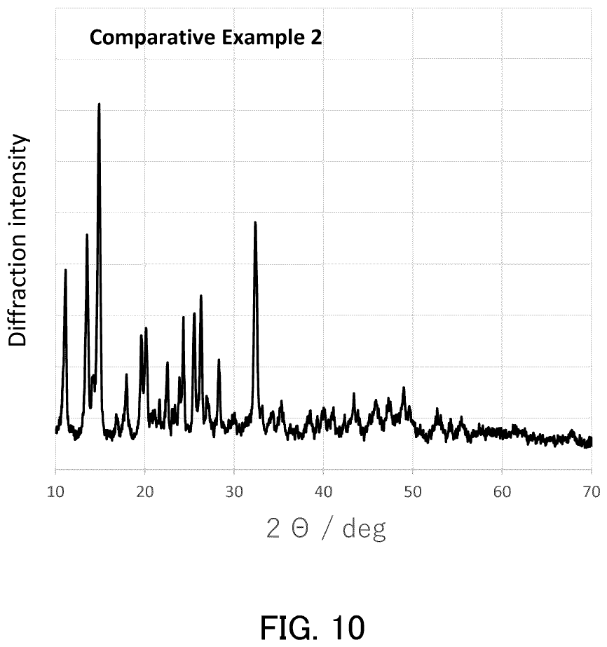

The solid electrolyte material according to Comparative Example 2 was subjected to X-ray diffraction measurement in the same manner as in Example 1. FIG. 10 shows a graph of the X-ray diffraction pattern of the solid electrolyte material according to

Comparative Example 2. The solid electrolyte material according to Comparative Example 2 had a crystalline peak pattern.

Table 1 shows the measurement results of the X-ray diffraction patterns of the solid electrolyte materials according to Example 1, Comparative Example 1, and Comparative Example 2, and the internal resistances and the interfacial resistances of the batteries using the solid electrolyte materials according to Example 1 and Comparative Example 1.

TABLE 1

| | | | Full width | | | |
|---|---|---|---|---|---|---|
| | | | at half | | Internal | Interfacial |
| | | | maximum | SN | resistance | resistance |
| | M | X | (°) | ratio | (Ωcm²) | (Ω) |
| Example 1 | Ta | Cl | 3.46 | 2.9 | 30.4 | 5.0 |
| Comparative | Ta | Cl | 0.15 | 30.0 | 33.7 | 6.1 |
| Example 1 | | | | | | |
| Comparative | Ta | Cl | 0.36 | 25.9 | — | — |
| Example 2 | | | | | | |

### Discussion

As shown in Table 1, the solid electrolyte material according to Example 1 has an extremely large full width at half maximum in the X-ray diffraction pattern compared to the solid electrolyte material according to Comparative Example 1.

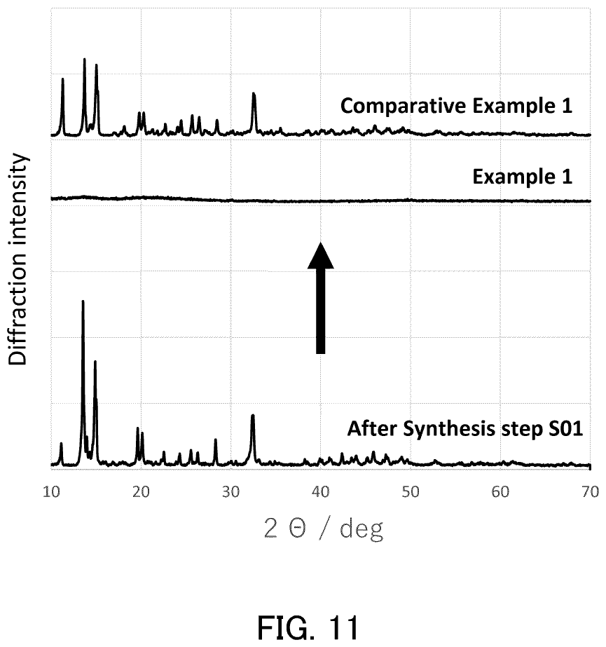

FIG. 11 shows graphs of the X-ray diffraction patterns of the compound after synthesis and before amorphization, the solid electrolyte material according to Example 1, and the solid electrolyte material according to Comparative Example 1. In the X-ray diffraction pattern, the solid electrolyte material according to Example 1 exhibits a halo pattern and does not have a peak having a full width at half maximum of less than 2° and an SN ratio of greater than 3, and consequently does not have a specific crystal structure. Therefore, the solid electrolyte material according to Example 1 is an amorphous material. In contrast, the solid electrolyte material according to Comparative Example 1 has, in the X-ray diffraction pattern, a peak having a full width at half maximum of less than 2° and an SN ratio of greater than 3 in a diffraction angle 2θ range from 10° to 20°.

Therefore, the solid electrolyte material according to Comparative Example 1 is a crystalline material that has not been amorphized. The solid electrolyte material according to Comparative Example 2 also has, in the X-ray diffraction pattern, a peak having a full width at half maximum of less than 2° and an SN ratio of greater than 3 in a diffraction angle 2θ range from 10° to 20°. Therefore, the solid electrolyte material according to Comparative Example 2 is confirmed to be a crystalline material that has not been amorphized.

In the case where a solid electrolyte material is amorphous as in Example 1, the crystal grain boundaries inside the material decrease, resulting in a reduction in internal resistance, which is resistance attributed to the grain boundaries. In fact, as described above, Example 1 exhibited a lower internal resistance than Comparative Example 1 for the duration from 0.1 seconds to 10 seconds. The low-frequency resistance from 0.1 seconds onward, that is, the internal resistance for the duration from 0.1 seconds to 10 seconds, is a portion corresponding to the grain boundary resistance. Furthermore, amorphous materials generally have a lower Young's modulus than crystalline materials. Accordingly, when used in batteries, amorphous materials enhance, for example, the coverage for the active material in the positive electrode mixture. This infers that the conduction paths for ionic conduction between the active material and the solid electrolyte material are increased, reducing the interfacial resistance.

Using Nb as M can also achieve a reduction in the internal resistance and interfacial resistance of batteries at a level comparable to that achieved in the example. The elements Ta and Nb are quite similar in chemical and electrical properties, making it possible to substitute a portion of Ta with Nb.

### INDUSTRIAL APPLICABILITY

The solid electrolyte material of the present disclosure is used, for example, in all-solid-state lithium-ion secondary batteries.

What is claimed is:

1. A solid electrolyte material comprising Li, M, O, and X, wherein the M is at least one selected from the group consisting of Nb and Ta, the X is at least one selected from the group consisting of F, Cl, Br, and I, the solid electrolyte material is amorphous, and in an X-ray diffraction pattern of the solid electrolyte material obtained by X-ray diffraction measurement using Cu—Kα radiation, a peak having a maximum intensity is present as a halo pattern in a diffraction angle 2θ range from 10° to 20°, and the peak has a full width at half maximum of 2° or more.

2. The solid electrolyte material according to claim 1, having a median diameter of 10 μm or less as determined from a volumetric particle size distribution measured with a laser diffraction scattering particle size analyzer.

3. The solid electrolyte material according to claim 1, wherein the M includes Ta.

4. The solid electrolyte material according to claim 1, wherein the X includes Cl.

5. The solid electrolyte material according to claim 1, having composition represented by the following composition formula (1):
LiₐMO_{b}X_{c} (1)
where 0.1≤a≤7.0, 0.4≤b≤1.9, and 1.0≤c≤11 are satisfied.

6. The solid electrolyte material according to claim 1, having composition represented by Li_{1.2}TaO_{0.8}Cl_{4.0}.

7. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer includes the solid electrolyte material according to claim 1.

8. A method for manufacturing the solid electrolyte material according to claim 1, the method comprising:
synthesizing a compound including Li, M, O, and X; and
amorphizing the compound, wherein
the M is at least one selected from the group consisting of Nb and Ta, and
the X is at least one selected from the group consisting of F, Cl, Br, and I.

9. The method according to claim 8, wherein
in the amorphizing the compound, the compound is subjected to a dry milling process.

10. The method according to claim 9, wherein
the dry milling process includes a process using a dry pot mill.

11. The method according to claim 9, wherein
the dry milling process uses a spherical medium having a diameter of 1 mm or more and 50 mm or less.

12. The method according to claim 8, wherein
the amorphizing the compound is conducted for 10 hours or more.

13. The method according to claim 8, wherein
the compound synthesized is crystalline before the amorphizing the compound.

14. The method according to claim 8, wherein
in the synthesizing the compound, the compound is synthesized by firing a raw material mixture.
